(19) United States
(12) Patent Application Publication
(10) Pub. No.: US 2025/0126106 A1
(43) Pub. Date: Apr. 17, 2025

(54) SYSTEM AND METHOD FOR AUTHENTICATING A VIRTUAL REPRESENTATION OF A USER IN A VIRTUAL ENVIRONMENT

(71) Applicant: SAMSUNG ELECTRONICS CO., LTD., Suwon-si (KR)

(72) Inventor: Vipul GUPTA, Noida (IN)

(73) Assignee: SAMSUNG ELECTRONICS CO., LTD., Suwon-si (KR)

(21) Appl. No.: 18/812,430

(22) Filed: Aug. 22, 2024

Related U.S. Application Data
(63) Continuation of application No. PCT/KR2024/010700, filed on Jul. 24, 2024.

(30) Foreign Application Priority Data
Oct. 17, 2023 (IN) 202311070667

(51) Int. Cl. H04L 9/40; G06T 19/00; G06T 19/20; G06V 20/20

(52) U.S. Cl. CPC H04L 63/08; G06T 19/006; G06T 19/20; G06V 20/20

(57) ABSTRACT

The present disclosure relates to a method and a system for authenticating a virtual representation of a user in a virtual environment. The method may include receiving an authentication request to authenticate the virtual representation of the first user in the virtual environment; based on the virtual representation of the first user being an authenticated virtual representation of the first user, extracting one or more authentication parameters embedded within the virtual representation of the first user; and displaying, in the virtual environment, authentication information of the virtual representation of the first user based on the one or more authentication parameters.

### CROSS-REFERENCE TO RELATED APPLICATION(S)

This application is a bypass continuation application, claiming priority under § 365 (c), from International application No. PCT/KR2024/010700, filed on Jul. 24, 2024, which claims the benefit of Indian Patent Application number 202311070667, filed on Oct. 17, 2023, in the Indian Intellectual Property Office, the disclosures of which are incorporated by reference herein in their entireties.

### BACKGROUND OF THE INVENTION

### 1. Field

The disclosure relates generally to virtual environment, and more particularly, to a system and method for authenticating a virtual representation of a user in the virtual environment.

### 2. Description of the Related Art

With the rapid advancements in technology, virtual environment has transformed from a mere concept to a fully immersive and interactive realm. This transformation has revolutionized the way humans perceive and interact with the world. In this virtual environment, users are represented by virtual representations, which enable them to interact with other users and enhance their sense of presence and interaction within the virtual space. However, this virtual environment also brings the risk of malicious human interactions aimed at deceiving users and exploiting their security vulnerabilities. These interactions involve the use of fake virtual representations, which can lead to the disclosure of sensitive information. Therefore, users must remain cautious of infiltrators who may use a combination of speech and visuals to impersonate virtual representations and mislead and deceive other users.

Furthermore, the virtual environment transcends physical boundaries, making users more vulnerable to global scammers and increasing the prominence of cybercrimes.

Therefore, it is crucial to develop an authentication system or method that ensures the security and privacy of virtual representations. This is necessary to prevent the virtual environment from becoming an abusive and dangerous space infested with criminals.

Numerous related art solutions exist that disclose the virtual representation authentication system and method.

In the related art, there is provided an avatar authentication system and avatar authentication method. The related art authentication system includes an authentication request unit responsible for transmitting a request to generate the electronic certificate of an avatar user. The authentication system further includes an electronic signature addition unit that adds an electronic signature to the avatar data. Further, the authentication system includes an avatar data transmission unit to transmit the avatar data with the electronic signature, an avatar presentation control unit to display the avatar based on the received avatar data, an electronic signature acquisition unit to retrieve the electronic signature of the avatar user from the avatar data, an authentication information acquisition unit to obtain an electronic certificate to authenticate the electronic signature, and a validity confirmation unit to verify the validity of the electronic signature using the electronic certificate.

However, the existing related art does not include extraction of authentication parameters and displaying authentication information to the user requesting the authentication of the virtual representation. These parameters are utilized to obtain authentication information generated using the authentication data provided by the user whose virtual representation requires authentication. Further, the related art is silent about determining location within the three-dimensional structure of the virtual representation for embedding the authentication information. This determination is based on factors such as the user's purpose, vision, behavior, and the type or purpose of the virtual environment. Additionally, the related art is silent about focusing on personalized authentication to verify presence of real self of the user behind the virtual representation with whom the user interacts in the virtual environment.

Further, the related art includes a three-dimensional (3D) avatar output device and method. The related art 3D avatar output device includes an input data receiving unit that is responsible for receiving input data that includes user information, a 3D avatar theme, and a 3D avatar output form. The 3D avatar output device further includes an image obtaining unit to capture an image of the user using a camera integrated into the 3D avatar output device, a restoration model generation unit to generate a restoration model by extracting the facial area from the captured image, a unique model generation unit to generate a unique model of the user based on the input data and the restoration model, and a 3D avatar output unit to generate a 3D avatar corresponding to the unique model and outputs the 3D avatar according to the specified 3D avatar output form.

However, the existing related art does not disclose extraction of authentication parameters and displaying authentication information to the user requesting the authentication of the virtual representation. These parameters are utilized to obtain authentication information generated using the authentication data provided by the user whose virtual representation requires authentication. Further, the related art is silent about determining location within the three-dimensional structure of the virtual representation for embedding the authentication information. This determination is based on factors such as the user's purpose, vision, behavior, and the type or purpose of the virtual environment. Additionally, the related art is silent about focusing on personalized authentication to verify presence of real self of the user behind the virtual representation with whom the user interacts in the virtual environment.

Therefore, in light of the foregoing discussion, there exists a need to overcome the aforementioned drawbacks associated with the existing system and method for authenticating a virtual representation of a user in a virtual environment.

### SUMMARY

The present disclosure provides a method for authenticating a virtual representation of a user in a virtual environment. The method includes receiving an authentication request to authenticate the virtual representation of the first user in the virtual environment; based on the virtual representation of the first user being an authenticated virtual representation of the first user, extracting one or more authentication parameters embedded within the virtual representation of the first user; and displaying, in the virtual environment, authentication information of the virtual representation of the first user based on the one or more authentication parameters.

An embodiment of the present disclosure provides a system for authenticating a virtual representation of a first user in a virtual environment. The system include memory storing one or more instructions; and at least one processor configured to execute the one or more instructions. The one or more instructions, when executed by the at least one processor, cause the system to implement an authentication initializer, configured to receive an authentication request of the virtual representation of the first user in the virtual environment and displaying authentication information; and a virtual representation debugger configured to, based on the virtual representation of the first user being an authenticated virtual representation of the first user, extract one or more authentication parameters embedded within the virtual representation.

An embodiment of the present disclosure provides a non-transitory computer-readable storage medium storing instructions. The instructions, that when executed for authenticating a first virtual representation of a first user in a virtual environment, cause at least one of one or more processors to receive, from a second user in the virtual environment or a second virtual representation of the second user, an authentication request to authenticate the first virtual representation of the first user in the virtual environment; and based on the first virtual representation of the first user being an authenticated virtual representation of the first user, displaying, to the second user, authentication information that is embedded within a translucent holographic three-dimensional structure of the first virtual representation, wherein the authentication information is invisible to other virtual representations present within the virtual environment.

The foregoing summary is illustrative only and is not intended to be in any way limiting. In addition to the illustrative aspects, embodiments, and features described earlier, further aspects, embodiments, and features will become apparent by reference to the drawings and the following detailed description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 depicts a flow diagram showing a method for authenticating a virtual representation of a user in a virtual environment, in accordance with one or more example embodiments of the present disclosure;

FIG. 2 depicts a block diagram of the system performing a method for authenticating the virtual representation of the user in the virtual environment, in accordance with one or more example embodiments of the present disclosure;

FIG. 3 depicts a block diagram of an authentication performing module for generating an authenticated virtual representation of the user, in accordance with one or more example embodiments of the present disclosure;

FIG. 4 depicts a block diagram of a virtual representation generating module, in accordance with one or more example embodiments of the present disclosure;

FIG. 5 depicts a block diagram of an authentication data collection module, in accordance with one or more example embodiments of the present disclosure;

FIG. 6 depicts a block diagram of an authentication embedded module, in accordance with one or more example embodiments of the present disclosure;

FIG. 7 depicts a flow diagram showing a method of working of the authentication embedded module for embedding authentication information data inside the three-dimensional structure of the virtual representation, in accordance with one or more example embodiments of the present disclosure;

FIG. 8 depicts a pictorial representation of process performed by the authentication embedded module, in accordance with one or more example embodiments of the present disclosure;

FIG. 9 depicts a flow diagram showing a method of working of the authentication performing module for generating the authenticated virtual representation of the user, in accordance with one or more example embodiments of the present disclosure;

FIG. 10 depicts a block diagram of providing authentication embedded virtual representation to an authentication virtual representation info hub for storage on a virtual environment server, in accordance with one or more example embodiments of the present disclosure; and

FIG. 11 depicts a first use case of authenticating the virtual representation of the user in the virtual environment, in accordance with one or more example embodiments of the present disclosure.

### DETAILED DESCRIPTION

In the following description, numerous specific details are set forth in order to provide a thorough understanding of the present disclosure. It will be apparent, however, to one skilled in the art that these specific details are only examples and not intended to be limiting. Additionally, it may be noted that the systems and/or methods are shown in block diagram form only in order to avoid obscuring the present disclosure. It is to be understood that various omissions and substitutions of equivalents may be made as circumstances may suggest or render expedient to cover various applications or implementations without departing from the spirit or the scope of the present disclosure. Further, it is to be understood that the phraseology and terminology employed herein are for the purpose of clarity of the description and should not be regarded as limiting.

Furthermore, in the present description, references to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily referring to the same embodiment, nor are separate or alternative embodiments mutually exclusive of other embodiments. Further, the terms “a” and “an” used herein do not denote a limitation of quantity, but rather denote the presence of at least one of the referenced items. Moreover, various features are described which may be exhibited by some embodiments and not by others. Similarly, various requirements are described, which may be requirements for some embodiments but not for other embodiments.

Various modules according to embodiments of the present disclosure may may be implemented by memory storing instructions and one or more processors configured to execute the instructions. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory.

The one or more processors may be implemented as one or more multi-core processors that include one or more cores (e.g., homogeneous multi-cores or heterogeneous multi-cores). When a plurality of cores are included in a processor, each of the cores includes a cache memory, and a common cache shared by the cores may be included in the processor. Each of the cores may independently read and execute program instructions or each of the cores may read and execute one or more portions of program instructions.

In embodiments of the disclosure, a processor may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

The virtual environment refers to a computer-generated space that simulates reality and allows users to interact with it through sensory stimuli. It can be experienced through various mediums such as virtual reality (VR), augmented reality (AR), or mixed reality (MR). The virtual environment encompasses a wide range of experiences, from gaming, content creation, social interaction, entertainment, healthcare, business to education and training.

The virtual environment has had a significant impact on society, with both positive and negative consequences. On the one hand, it has created new avenues for creativity, education, and entertainment. It has also facilitated connections between people from different parts of the world, breaking down geographical barriers and fostering global interactions.

However, concerns related to privacy have emerged as a result. The existence of fake virtual representations that closely resemble real users' virtual representations, including their visual expressions and speech, can deceive other users and lead to security breaches or the inadvertent disclosure of sensitive information within the virtual environment.

Additionally, the presence of multiple users with similar virtual representations further complicates the identification of the true or intended user behind a particular virtual representation. This ambiguity may create challenges in distinguishing between original users and potential impostors within the virtual environment. Therefore, authenticating a virtual representation of the user in the virtual environment is crucial to enable the user to enjoy all the benefits of the virtual environment.

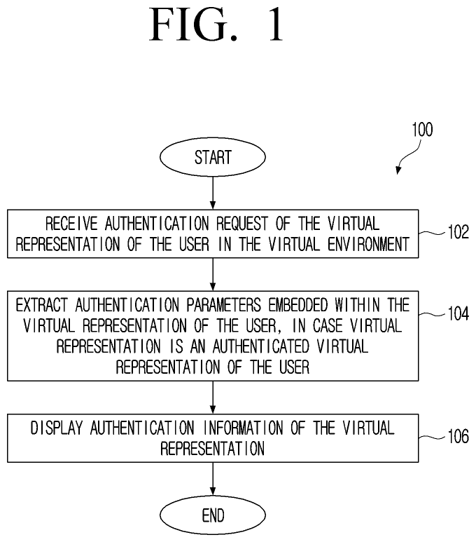

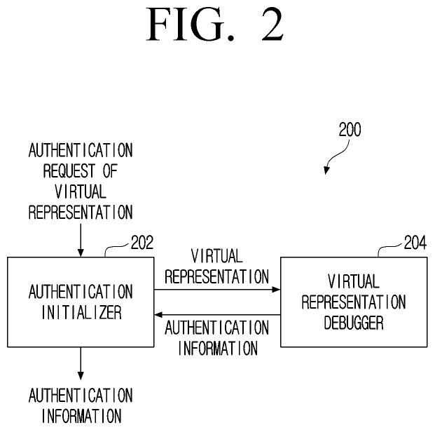

Referring to FIG. 1, a flow diagram showing a method (100) for authenticating a virtual representation of a user in a virtual environment is disclosed. The method may be explained in conjunction with the system disclosed in FIG. 2. In the flow diagram, each block represents a module, segment, or portion of code that contains one or more executable instructions for implementing specific logical functions. It is important to note that in certain alternative implementations, the sequence of functions shown in the drawings may not occur exactly in the order indicated. For instance, two blocks displayed consecutively in FIG. 1 may be executed concurrently, or the blocks may be executed in reverse order depending on the specific functionality involved.

Any descriptions or blocks in the flowcharts should be understood as representing segments, modules, or portions of code that include executable instructions for implementing specific logical functions or steps in the process. Alternate implementations are also within the scope of the example embodiments, where functions may be executed out of order from what is shown or discussed. This includes the possibility of executing functions substantially concurrently or in reverse order, depending on the specific functionality involved.

Additionally, the process descriptions or blocks in the flowcharts should be understood as representing decisions made by a hardware structure, such as a state machine. The flow diagram starts at operation (102) and proceeds to operation (106).

At operation 102, an authentication request of the virtual representation of the user in the virtual environment is received. The authentication request is received by a person or any other user present in the virtual environment through various means. In one embodiment, the means of receiving an authentication request in a virtual environment may include, but are not limited to, voice command, facial gesture, indication involving pointing towards the virtual representation, selection by clicking on the virtual representation, and inputting user credentials such as username.

For example, the person can provide an authentication request by speaking a specific phrase or command or can also use facial expressions or gestures to indicate his intent to authenticate. Another example is to physically point towards the virtual representation of the user to signify his authentication request. Additionally, the person can initiate the authentication process by clicking or selecting the virtual representation of the user present in the virtual environment. The person can also enter name of the user or other required credentials using keyboard input or other input methods within the virtual environment.

It is important to note that these examples are not exhaustive, and there may be other means of authentication available depending on the specific implementation. The chosen means may be influenced by factors such as accessibility, user preference, or the capabilities of the virtual environment platform. It should be noted that authentication request involves the virtual representation of the user selected by the user within the virtual environment to initiate a process of authentication.

Successively, authentication parameters embedded within the virtual representation of the user is extracted, at operation 104. In one embodiment, the authentication parameters embedded within the virtual representation of the user are extracted when virtual representation is an authenticated virtual representation of the user. Subsequently, authentication information is obtained in response to the extracted authentication parameters for the virtual representation of the user. In another case, if the authentication is not present for the virtual representation of the user, the user is requested to provide authentication data. This data is then used to generate authentication information for the user. The generated authentication information is subsequently embedded within a holographic three-dimensional structure of the virtual representation and stored on the server. This stored information is then be retrieved in response to the extracted authentication parameters for the user's virtual representation.

In an example embodiment, the authentication information may be an authenticity certificate which is obtained for the virtual representation in response to the authentication parameters. It should be noted that the authenticity certificate typically contains cryptographic information, such as digital signatures or hashes that can be used to verify authenticity of the virtual representation. This certificate acts as proof that the virtual representation is genuine and has not been tampered with.

The use of an authenticity certificate adds an additional layer of security and trust to the virtual representation. It ensures that the virtual representation is of the same user and has not been modified or manipulated. By embedding this authenticity certificate within the holographic three-dimensional structure of the virtual representation, it becomes an integral part of the representation itself. This means that the certificate is inseparable from the virtual representation and can be easily verified whenever the representation is accessed or used.

The inclusion of the authentication information in the authentication process provides assurance to users that the virtual representation they are interacting with is legitimate and trustworthy. It helps establish a secure and reliable virtual environment for various applications, such as but not limited to, virtual meetings, virtual training, or virtual transactions.

Thereafter, the authentication information of the virtual representation is displayed, at operation 106. In one embodiment, the authentication information is displayed to requesting user via the virtual environment provider.

It should be noted that the virtual environment provider refers to a company or service that offers infrastructure and tools necessary to create and manage virtual environments. These providers offer resources such as virtual machines, networks, storage, and other virtualized components that allow users to run multiple operating systems and applications within isolated and independent environments. The virtual environment providers can be cloud service providers, virtualization software vendors, or hosting companies that specialize in offering virtualization services. Some well-known virtual environment providers include Microsoft Azure, Amazon Web Services (AWS), VMware, Google Cloud Platform, and Oracle VM VirtualBox.

Referring to FIG. 2, a block diagram of the system performing method for authenticating a virtual representation of a user in a virtual environment is disclosed, in accordance with one or more example embodiments of the present disclosure. In an example embodiment, the virtual environment in the present disclosure can be implemented through the use of virtualization technology such as VMware or VirtualBox. This involves creating virtual machines (VMs) that run on a physical host machine. Each VM operates as a separate and isolated environment, with its own operating system, applications, and resources.

Containerization is an alternative approach to virtualization that focuses on lightweight and portable application deployment.

Cloud computing platforms, such as Amazon Web Services (AWS™) or Microsoft Azure, offer the ability to create virtual environments in the cloud. These environments can be provisioned and managed remotely, allowing for easy scalability and resource allocation. Cloud-based virtual environments provide the advantage of flexibility, as they can be accessed from anywhere with an internet connection and can easily accommodate changing resource needs.

The virtual environment, in context of virtual reality refers to a simulated three-dimensional space that can be interacted with using specialized hardware, such as VR headsets or controllers. Virtual reality environments immerse users in a computer-generated world, providing a highly immersive and interactive experience.

Augmented reality involves overlaying computer-generated elements onto the real world, enhancing the user's perception and interaction with their environment. It's important to note that the specific implementation of the virtual environment depends on the intended use, available resources, and desired functionality.

As depicted, the system (200) comprises an authentication initializer (202), which may be implemented in hardware using a processor, that is configured to receive an authentication request of the virtual representation of the user in the virtual environment and display authentication information. In one embodiment, the authentication information is embedded inside a translucent holographic three-dimensional structure of the virtual representation. This embedded authentication information is specifically displayed to the requesting user, ensuring that the user can see and access it.

However, it may be invisible or hidden to other virtual representations that exist within the virtual environment. It should be noted that the use of the translucent holographic three-dimensional structure for the virtual representation offers benefits in terms of realism, depth perception, interaction, visualization, immersion, and engagement. It enhances the user experience and enables a more effective communication of information within the virtual environment. Therefore, the authentication information is visible only to the requesting user, ensuring easy verification of the virtual representation's authenticity. This structure, however, is intentionally designed to be invisible to other virtual representations within the environment. This segregation ensures the confidentiality of the authentication information and prevents unauthorized access or tampering by other virtual representations.

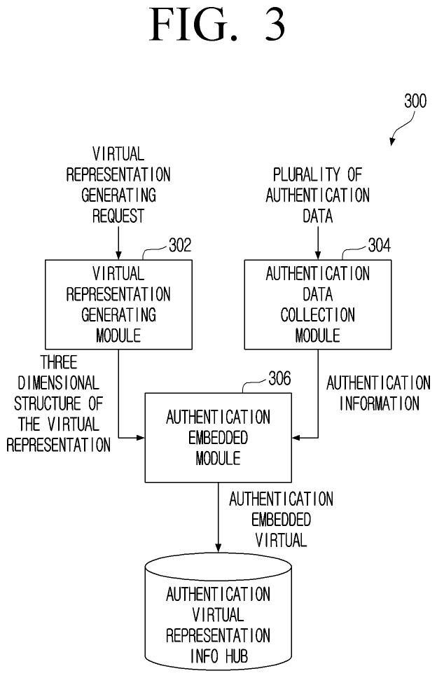

The system (200) further comprises a virtual representation debugger (204), which may be implemented in hardware using a processor, that is configured to receive a three-dimensional structure of the virtual representation based on the authentication request. The virtual representation debugger (204) then proceeds to debug the structure to in order to identify the authentication parameters that are embedded within the virtual representation. Once identified, the virtual representation debugger (204) extracts these authentication parameters within the virtual representation, and retrieves the authentication information if the virtual representation is an authenticated virtual representation. The generation of the authenticated virtual representation is explained in detail in FIG. 3.

The virtual representation debugger (204) is further configured to provide the authentication information to the authentication initializer (202), enabling the display of the authentication information to the user making the request. In case, when the authentication is not present for the virtual representation of the user, the user is requested to provide authentication data. This data is used to generate the authentication information for the user. Once generated, this authentication information is embedded within a holographic three-dimensional structure of the virtual representation, resulting in the creation of the authenticated virtual representation.

Referring to FIG. 3, a block diagram of an authentication performing module (300) is depicted, in accordance with one or more example embodiments of the present disclosure. As depicted, the authentication performing module (300) comprises a virtual representation generating module (302) (which may be implemented in hardware using a processor). In one embodiment, the virtual representation generating module (302) is configured to receive a request for generating a three-dimensional structure of the virtual representation. The request may be received in one of two ways, including generating a new three-dimensional structure of the virtual representation or requesting the three-dimensional structure from a list of available virtual representations within the virtual environment. It should be noted that the request for generating the three-dimensional structure may be made at the time the user enters the virtual environment.

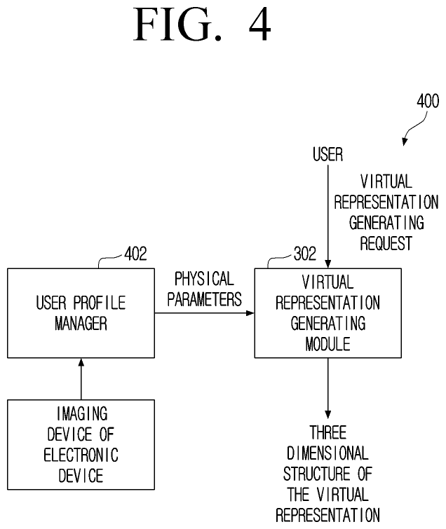

In an example embodiment, when the user enters the virtual environment, the user is required to select the virtual representation. This selection can be made from a list of pre-existing virtual representations that are already available within the virtual environment. Alternatively, the user may request the generation of the new three-dimensional structure of the virtual representation, which is explained in detail in FIG. 4.

Referring to FIG. 4, a block diagram of the virtual representation generating module (302) is depicted, in accordance with one or more example embodiments of the present disclosure. As depicted, the virtual representation generating module (302) is configured to generate the new three-dimensional structure of the virtual representation upon receiving the request of generating the new virtual representation from the user. To generate the new three-dimensional structure of the virtual representation, the virtual representation generating module (302) utilizes input data received from a user profile manager (402) (which may be implemented in hardware using a processor). In one embodiment, the input data may include physical parameters of the user, which are captured by an imaging device of the electronic device. An example of the imaging device in the context of electronic devices may include, but not limited to, a digital camera or a phone camera or any other type of imaging device.

These physical parameters may include various attributes such as height, weight, body proportions, and other relevant measurements. It should be noted that the imaging device is responsible for capturing the necessary data to accurately represent the user's physical characteristics in the virtual environment. This may involve capturing images, depth maps, or other types of data that provide a detailed representation of the user's physical appearance.

By incorporating the user's physical parameters into the generation process, the virtual representation generating module (302) may be able to create the new three-dimensional structure that closely resembles the user's actual physical attributes. This level of accuracy enhances the realism and authenticity of the virtual representation, resulting in a more immersive and engaging user experience within the virtual environment.

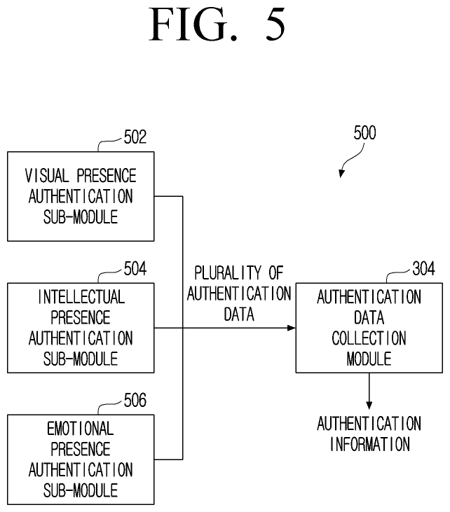

The authentication performing module (300) further comprises an authentication data collection module (304) (which may be implemented in hardware using a processor). In one embodiment, the authentication data collection module (304) is configured to capture a plurality of authentication data from the user to create the authentication information. The plurality of authentication data may include at least visual presence authentication data, intellectual presence authentication data, and emotional presence authentication data, which is explained in detail in FIG. 5.

Referring to FIG. 5, a block diagram of the authentication data collection module (304) is depicted, in accordance with one or more example embodiments of the present disclosure. As depicted, the authentication data collection module (304) is configured to capture a plurality of authentication data from a plurality of sub-modules such as a visual presence authentication sub-module (502) (which may be implemented in hardware using a processor), an intellectual presence authentication sub-module (504) (which may be implemented in hardware using a processor), and an emotional presence authentication sub-module (506) (which may be implemented in hardware using a processor).

In one embodiment, the visual presence authentication sub-module (502) is configured to provide data related to visual presence of the user. This data may include motion video of the user, which is captured and encoded in an encrypted data format. The purpose of capturing and encoding this motion video is to verify the physical presence of the user behind the virtual representation.

The intellectual presence authentication sub-module (504) is configured to provide data related to intellectual presence of the user, which includes at least, but not limited to, a one-time password, object recognition in an image, and basic mathematical operations to verify user's awareness and cognitive engagement behind the virtual representation and to ensure actual presence of the user behind the virtual representation.

The emotional presence authentication sub-module (506) is configured to provide data related to emotional presence of the user, which includes at least, but not limited to, Natural language Processing based text response behavior or analysis of the user's facial expression to verify emotional state and presence of the virtual representation with respect to the user.

The authentication data collection module (304) is further configured to create the authentication information using the captured plurality of authentication data.

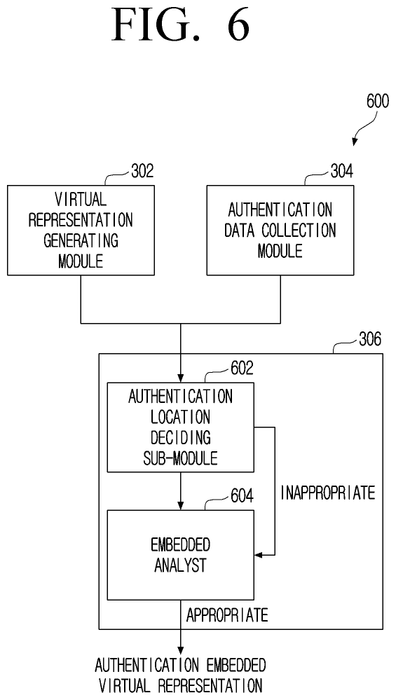

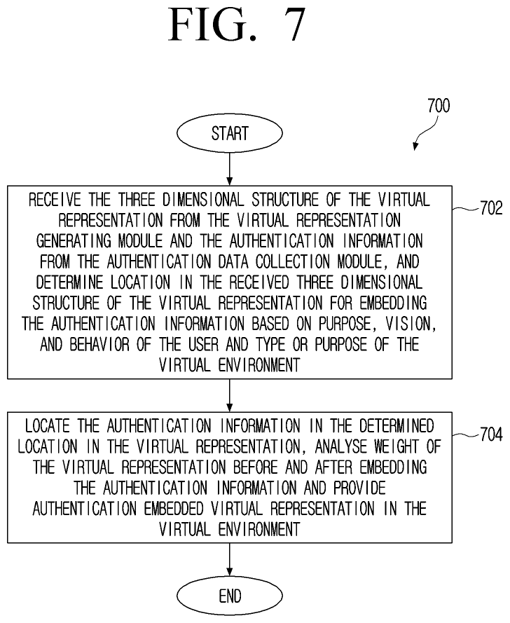

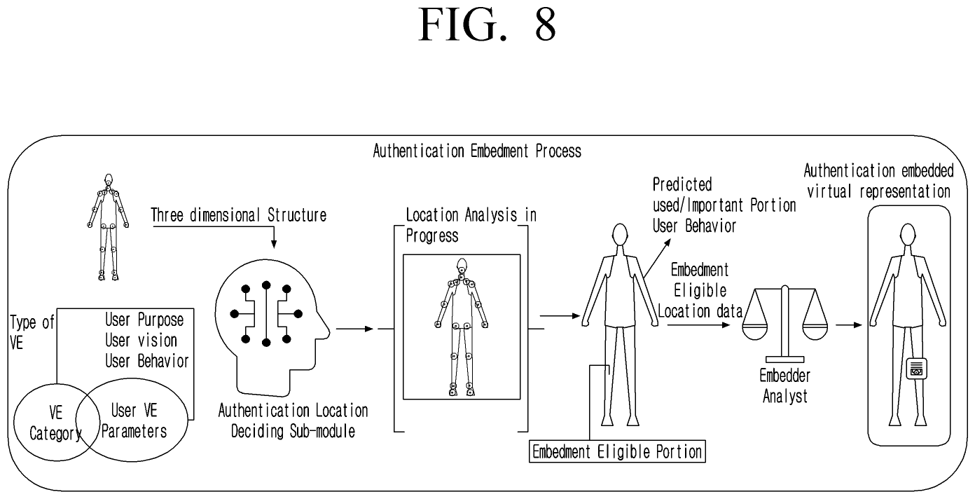

The authentication performing module (300) further comprises an authentication embedded module (306) (which may be implemented in hardware using a processor). In one embodiment, the authentication embedded module (306) is configured to embed the authentication information within the three-dimensional structure of the virtual representation. It should be noted that the authentication embedded module (306) is responsible for integrating the authentication information into the virtual environment with respect to the three-dimensional structure, creating an authentication embedded virtual representation, which is explained in detail in FIG. 6, FIG. 7, and FIG. 8.

Referring to FIG. 6, a block diagram of the authentication embedded module (306) is depicted, in accordance with one or more example embodiments of the present disclosure. As depicted, the authentication embedded module (306) comprises an authentication location deciding sub-module (602) (which may be implemented in hardware using a processor), which is configured to receive three-dimensional structure of the virtual representation from the virtual representation generating module (302) and the authentication information from the authentication data collection module (304). The authentication embedded module (306) is further configured to determine location in the received three-dimensional structure of the virtual representation for embedding the authentication information. This determination is based on several factors, including the purpose, vision, and behavior of the user, as well as the type or purpose of the virtual environment.

The authentication embedded module (306) further comprises an embedded analyst (604) (which may be implemented in hardware using a processor), which is configured to locate the authentication information in the determined location in the virtual representation. Additionally, the embedded analyst (604) is configured to analyze weight of the virtual representation both before and after embedding the authentication. When the weight of the virtual representation remains unchanged after embedding the authentication information or falls within the suitability parameters of the virtual environment, the authentication embedded virtual representation is provided in the virtual environment.

However, in an inappropriate scenario where the weight of the virtual representation increases after embedding the authentication information, the authentication location deciding sub-module (602) is triggered for determining the location of the authentication information within the received three-dimensional structure of the virtual representation again till the appropriate location is determined. The main purpose of determining the location is to ensure that the weight of the virtual representation remains constant. This is important because if the virtual representation becomes too heavy, it can put a burden on the server.

Referring to FIG. 7, a flow diagram showing a method of working of the authentication embedded module (306) for embedding authentication information data inside the three-dimensional structure of the virtual representation is depicted, in accordance with one or more example embodiments of the present disclosure.

As depicted, the method includes receiving three-dimensional structure of the virtual representation from the virtual representation generating module (302) and the authentication information from the authentication data collection module (304), and determining location in the received three-dimensional structure of the virtual representation, at operation 702, for embedding the authentication information. In one embodiment, the authentication information is embedded based on purpose, vision, and behavior of the user and type or purpose of the virtual environment. In an embodiment, one or more authentication data is embedded based on purpose, vision, and behavior of the user and type or purpose of the virtual environment.

The method further includes, locating the authentication information data in the determined location in the virtual representation, analyzing weight of the virtual representation before and after embedding the authentication information and providing authentication embedded virtual representation in the virtual environment, at operation 704.

Referring to FIG. 8, a pictorial representation of process performed by the authentication embedded module is depicted. As depicted, the authentication location deciding sub-module (602) determines the type and use of the virtual environment, taking into consideration factors such as the user's vision, purpose, and behavior. It then provides an eligible portion of the virtual representation for embedding the authentication information to the embedded analyst.

In an example embodiment, where the purpose of the virtual representation is shopping, knee is considered as the least important portion of the virtual representation. As a result, this specific portion of the virtual representation is selected for embedding the authentication information. This chosen portion, which includes the knee, is then provided to the embedded analyst. The embedded analyst then embeds the authentication information in the knee by removing data from that portion to maintain the weight of the virtual representation constant. By embedding the authentication information in a less significant part of the virtual representation, the overall integrity and security of the authentication process can be maintained without significantly impacting the visual or functional aspects of the virtual representation.

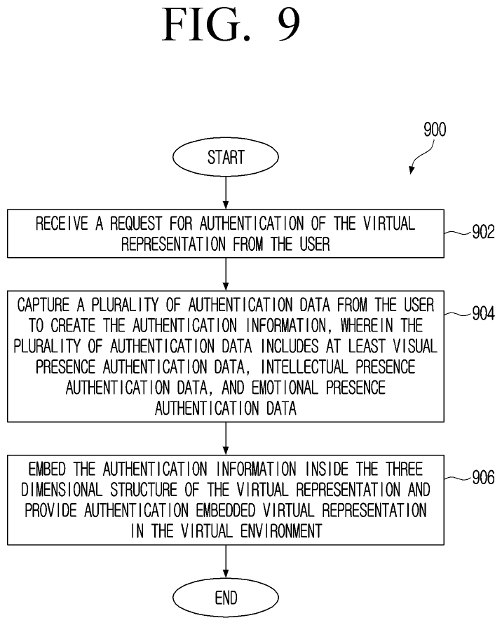

Referring to FIG. 9, a flow diagram showing a method of working of the authentication performing module (300) for generating the authenticated virtual representation of the user is depicted, in accordance with one or more example embodiments of the present disclosure. The method includes receiving the request for authentication of the virtual representation from the user, at operation 902.

Successively, capturing a plurality of authentication data from the user to create the authentication information, at operation 904. In one embodiment, the plurality of authentication data includes at least visual presence authentication data, intellectual presence authentication data, and emotional presence authentication data.

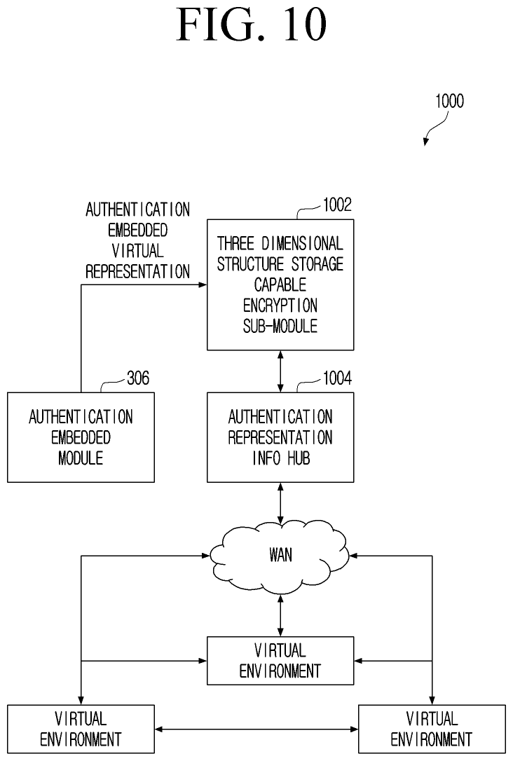

Thereafter, embedding the authentication information inside the three-dimensional structure of the virtual representation and providing authentication embedded virtual representation in the virtual environment, at operation 906. In an embodiment, the authentication embedded virtual representation is provided to an authentication virtual representation info hub for storage on the virtual environment server, which is explained in detail in FIG. 10.

Referring to FIG. 10, a block diagram of providing authentication embedded virtual representation to an authentication virtual representation info hub for storage on a virtual environment server is depicted. As depicted, the authentication embedded virtual representation from the authentication embedded module (306) is at first encrypted by a three-dimensional structure storage capable encryption sub-module (1002) (which may be implemented in hardware using a processor) to make storage capable and then provided to the authentication virtual representation info hub (1004) (which may be implemented in hardware using a processor).

It should be noted that the three-dimensional structure storage capable encryption sub-module (1002) applies encryption techniques specifically designed for three-dimensional structures of the virtual representation, allowing the authentication embedded virtual representation to be stored in a secure manner. The authentication virtual representation info hub (1004) is configured to utilize a wireless network, such as a Wide Area Network (WAN), to establish an interconnection with the virtual environment. This enables seamless communication and data transfer between the authentication virtual representation info hub and the virtual environment server. It should be noted that the authentication virtual representation info hub (1004) serves as a central storage and management system for authentication-related virtual representations.

By utilizing a wireless network, the authentication virtual representation info hub can efficiently transmit and receive data, ensuring timely access to the authentication embedded virtual representations stored on the virtual environment server.

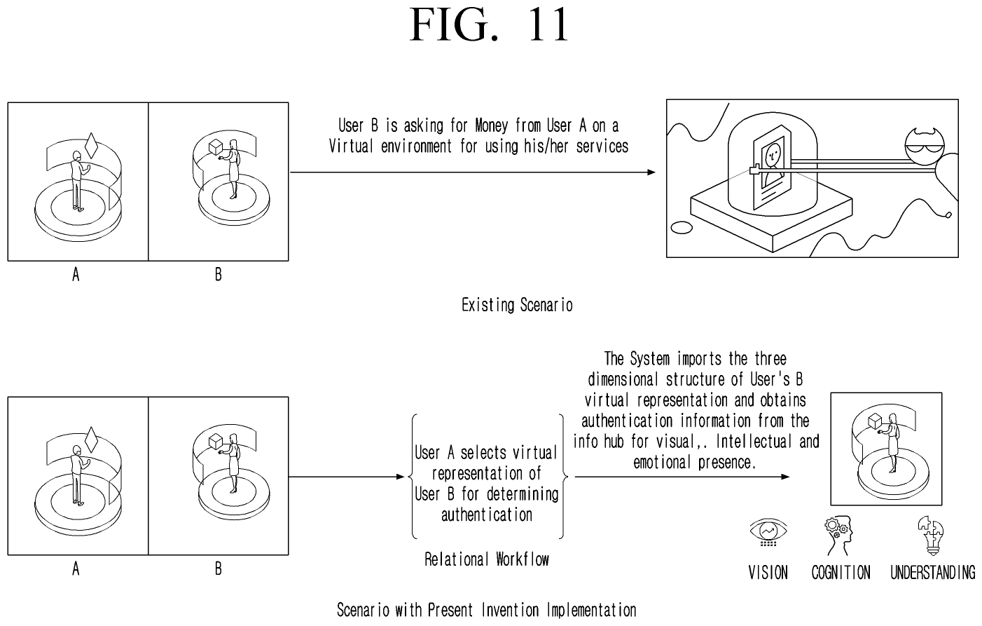

Referring to FIG. 11, a first use case of authenticating the virtual representation of the user in the virtual environment is depicted, in accordance with one or more example embodiments of the present disclosure. As depicted in the existing scenario of user's virtual representation on a financial virtual environment platform, User A, a businessman, and User B, a friend and an IT company professional, are involved. User B requests money from User A on the virtual environment in exchange for services.

However, in the current mechanism, there is no reliable way to authenticate the real identity of the person behind the virtual representation on the virtual environment. This lack of authentication poses a significant risk of virtual representation cloning or the presence of an imposter behind the virtual representation, leading to potential financial fraud and loss due to a lack of authenticity.

To address this issue, the present disclosure provides a solution for users to authenticate the real identity of other users behind their virtual representations before engaging in secure information transactions. In this case, the User A selects the virtual representation of User B to verify its authenticity. The system imports the three-dimensional structure of User B's virtual representation and checks it for visual, intellectual, and emotional presence through the info hub. This authentication process ensures a more secure transfer of sensitive information, reducing the risk of fraudulent activities.

Hence, by implementing the present disclosure, users are empowered with a mechanism to authenticate the real identity of individuals behind their virtual representations. This enhances the security and trustworthiness of the virtual environment, mitigating the risk of financial fraud and loss due to the lack of authenticity in virtual interactions.

It has thus been seen that the system and method for authenticating the virtual representation of the user in the virtual environment according to the present invention achieve the purposes highlighted earlier. Such a system and method can in any case undergo numerous modifications and variants, all of which are covered by the same innovative concept, moreover, all of the details can be replaced by technically equivalent elements. The scope of protection of the disclosure is therefore defined by the attached claims.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

What is claimed is:

1. A method for authenticating a virtual representation of a first user in a virtual environment, the method comprising:
receiving an authentication request to authenticate the virtual representation of the first user in the virtual environment;
based on the virtual representation of the first user being an authenticated virtual representation of the first user, extracting one or more authentication parameters embedded within the virtual representation of the first user; and
displaying, in the virtual environment, authentication information of the virtual representation of the first user based on the one or more authentication parameters.

2. The method of claim 1, wherein the authentication request is received from a second user in the virtual environment, and
wherein the authentication request is received as one of: a voice command, a facial gesture, an indication involving pointing towards the virtual representation, a selection by clicking on the virtual representation, and inputting of user credentials.

3. The method of claim 1, wherein the receiving the authentication request comprises:
generating a three-dimensional structure of the virtual representation of the first user by generating a new three-dimensional structure or by requesting the three-dimensional structure from a list of available virtual representations associated with the first user within the virtual environment.

4. The method of claim 1, further comprising:
receiving a three-dimensional structure of the virtual representation of the first user based on the authentication request; and
identifying the one or more authentication parameters embedded within the virtual representation from the three-dimensional structure of the virtual representation of the first user.

5. The method of claim 1, further comprising, based on the virtual representation of the first user not being the authenticated virtual representation:
generating the authentication information of the virtual representation of the first user, and
providing the authenticated virtual representation based on embedding the authentication information in a holographic three-dimensional structure of the virtual representation.

6. The method of claim 1, further comprising:
generating the authenticated virtual representation by:
receiving a request for authentication of the virtual representation from the second user;
capturing a plurality of authentication data from the first user to create the authentication information, wherein the plurality of authentication data comprises at least one of a visual presence authentication data, an intellectual presence authentication data, and an emotional presence authentication data;
embedding the authentication information within a three-dimensional structure of the virtual representation; and
providing authentication embedded virtual representation in the virtual environment.

7. The method of claim 3, wherein the new three-dimensional structure of the virtual representation is generated by using an input data that comprises physical parameters received from a user profile manager on receiving the authentication request, and the physical parameters of the first user are captured by an imaging device of an electronic device.

8. The method of claim 6, wherein the embedding the authentication information within the three-dimensional structure of the virtual representation comprises:
receiving the three-dimensional structure of the virtual representation and the authentication information;
determining a location in the three-dimensional structure of the virtual representation for embedding the authentication information based on a purpose, a vision, and a behavior of the first user and a type or a purpose of the virtual environment; and
embedding the authentication information in the location in the virtual representation, analyzing weight of the virtual representation before and after embedding the authentication information and providing the authentication embedded virtual representation in the virtual environment.

9. The method of claim 6, wherein the authentication information is embedded in a translucent holographic three-dimensional structure of the virtual representation that is invisible to other virtual representations present within the virtual environment.

10. The method of claim 6, wherein the authentication embedded virtual representation is provided to an authentication representation info hub for storage on a virtual environment server.

11. A system for authenticating a virtual representation of a first user in a virtual environment, the system comprising:
memory storing one or more instructions; and
at least one processor configured to execute the one or more instructions,
wherein the one or more instructions, when executed by the at least one processor, cause the system to implement:
an authentication initializer, configured to receive an authentication request of the virtual representation of the first user in the virtual environment and displaying authentication information; and
a virtual representation debugger configured to, based on the virtual representation of the first user being an authenticated virtual representation of the first user, extract one or more authentication parameters embedded within the virtual representation.

12. The system of claim 11, wherein the one or more instructions, when executed by the at least one processor, further cause the system to implement:
a virtual personification generator configured to generate a three-dimensional structure of the virtual representation by one of generating a new three-dimensional structure or requesting the three-dimensional structure from a list of available virtual representations within the virtual environment.

13. The system of claim 11, wherein the authentication request is received as one of: a voice command, a facial gesture, an indication involving pointing towards the virtual representation, a selection by clicking on the virtual representation, or inputting of user credentials.

14. The system of claim 11, wherein the one or more instructions, when executed by the at least one processor, further cause the system to implement:
an authentication performer configured to generate the authenticated virtual representation of the first user, and
wherein the authentication performer comprises:
a virtual representation generator configured to receive a request for authentication of the virtual representation from the first user;
an authentication data collector configured to capture a plurality of authentication data from the first user to create the authentication information, wherein the plurality of authentication data comprises at least one of a visual presence authentication data, an intellectual presence authentication data, and an emotional presence authentication data; and
an authentication embedder configured to embed the authentication information within a three-dimensional structure of the virtual representation and provide authentication embedded virtual representation in the virtual environment.

15. The system of claim 14, wherein the authentication embedder comprises:
an authentication location decider configured to receive the three-dimensional structure of the virtual representation and the authentication information, and determine a location in the three-dimensional structure of the virtual representation for embedding the authentication information based on a purpose, a vision, and a behavior of the first user and a type or a purpose of the virtual environment; and
an embedding analyzer configured to embed the authentication information in the location in the virtual representation, analyze weight of the virtual representation before and after embedding the authentication information and provide the authentication embedded virtual representation in the virtual environment.

16. A non-transitory computer-readable storage medium storing instructions, that when executed for authenticating a first virtual representation of a first user in a virtual environment, cause at least one of one or more processors to:
receive, from a second user in the virtual environment or a second virtual representation of the second user, an authentication request to authenticate the first virtual representation of the first user in the virtual environment; and
based on the first virtual representation of the first user being an authenticated virtual representation of the first user, displaying, to the second user, authentication information that is embedded within a translucent holographic three-dimensional structure of the first virtual representation,
wherein the authentication information is invisible to other virtual representations present within the virtual environment.

17. The non-transitory computer-readable storage medium of claim 16, wherein the authentication request is received as one of: a voice command, a facial gesture, an indication involving pointing towards the first virtual representation, a selection by clicking on the first virtual representation, or inputting of user credentials.

18. The non-transitory computer-readable storage medium of claim 16, wherein the instructions further cause the at least one of the one or more processors to, based on the first virtual representation of the first user not being the authenticated virtual representation:
generate the authentication information of the first virtual representation of the first user; and
provide the authenticated virtual representation based on embedding the authentication information in a holographic three-dimensional structure of the first virtual representation.

19. The non-transitory computer-readable storage medium of claim 16, wherein generating the authenticated virtual representation of the first user comprises:
receiving a request for authentication of the first virtual representation from the first user;
capturing a plurality of authentication data from the first user to create the authentication information, wherein the plurality of authentication data comprises at least one of a visual presence authentication data, an intellectual presence authentication data, and an emotional presence authentication data;
embedding the authentication information within a three-dimensional structure of the first virtual representation; and
providing authentication embedded virtual representation in the virtual environment.

20. The non-transitory computer-readable storage medium of claim 19, wherein embedding the authentication information within the three-dimensional structure comprises:
receiving the three-dimensional structure of the first virtual representation and the authentication information;
determining a location in the three-dimensional structure of the first virtual representation for embedding the authentication information based on a purpose, a vision, and a behavior of the first user and a type or a purpose of the virtual environment; and
embedding the authentication information in the location in the first virtual representation, analyzing weight of the first virtual representation before and after embedding the authentication information and providing the authentication embedded virtual representation in the virtual environment.
